(19) United States
(12) Patent Application Publication
(10) Pub. No.: US 2017/0044777 A1
(43) Pub. Date: Feb. 16, 2017

(54) INTERLOCKING CUSHIONED TILES FROM CRUMB RUBBER

(71) Applicants: Ryan Peterson, Fontana, CA (US); Richard Posiviata, Fontana, CA (US)

(72) Inventors: Ryan Peterson, Fontana, CA (US); Richard Posiviata, Fontana, CA (US)

(21) Appl. No.: 14/822,610

(22) Filed: Aug. 10, 2015

(51) Int. Cl. E04F 15/10; B29C 39/00; B29C 39/24; E04F 15/02; B29C 35/02

(52) U.S. Cl. CPC E04F 15/107; E04F 15/02038; E04F 15/02177; B29C 35/0227; B29C 39/24; B29C 39/003; E04F 2201/0107; E04F 2201/023; E04F 2290/02; B29L 2031/732

(57) ABSTRACT

Improvements in interlocking cushioned tiles from crumb rubber for the bulk of the tile to be made from recycled tire rubber with virgin material at interlocking areas of the tiles is disclosed. The use of recycled rubber reduces the amount of material in landfills. The density and size of the crumbs is variable to alter the amount of cushion for the tiles. Virgin material bonds easily together and the bonded virgin material has high integrity to keep the interlocking keyed elements together. The interconnection exists on all sides of the tiles and allows for a nearly infinite amount of tiles that can be connected to cover small and large areas. The connection details are essentially lollipop type interconnection male and female members. The interlocking cushioned tiles further include a drain and area for wiring to run under the tiles.

### CROSS REFERENCE TO RELATED APPLICATIONS

This application claims the benefit of Provisional Application Ser. No. 62/041,586 filed Aug. 25, 2014 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

This invention relates to improvements in cushioned interlocking flooring. More particularly, the present interlocking cushioned tiles made from virgin and crumb rubber creates a tightly connectable flooring that expands and contracts without harming the structural integrity of the tiles.

Description of Related Art including information disclosed under 37 CFR 1.97 and 1.98.

Interconnecting flooring is used in a variety of areas. Cushioned interconnecting flooring is used in areas where there is a potential impact from someone or something falling onto the ground or being dropped onto the ground. This type of cushioned flooring is often used in athletic areas or where children play. One common material for floor cushioning is crumb rubber made from recycled tires.

Flooring made from crumb rubber is often formed in large areas and not made from individual tiles. Forming the cushioned flooring with squares of 100% crumb rubber is susceptible to damage because crumb rubber interconnecting easily fail due to the brittle nature of bonded crumb rubber. Another method of making the individual tiles is with all new rubber, but the cost of using new rubber material is expensive and often requires creating voids in the part to increase the cushion.

A number of patents and or publications have been made to address these issues. Exemplary examples of patents and or publication that try to address this/these problem(s) are identified and discussed below.

U.S. Pat. No. 2,999,431 issued Sep. 12, 1961 to Robert L. Mitchell discloses a Resilient Mat Construction. This patent is made from virgin rubber and is formed as puzzle pieces. While the resilient mat provides a cushioned surface the base material is virgin rubber and expensive to produce and expansion along the multiple assembled mats can cause bunching of the tiles. This construction further does not allow for routing wiring or a raised area for drainage under the mat.

U.S. Pat. No. 7,676,995 issued on Mar. 16, 2010 to John F. Vanderhoef discloses Interlocking Tiles. These tiles interlock on one or more sides with a “U” shaped cross-section. The interlocking section essentially lock together with a gravity engagement. This type of engagement can ripple along the interlocking sections when the tiles are impacted from weights or from a person stepping in the interlocking region. The tiles do not provide a positive lock that retains the tiles in different orientations.

U.S. Pat. No. 4,287,693 issued on Sep. 8, 1981 to Roderick E. Collette discloses an Interlocking Rubber Mat with wedge fitting tile pieces. The tiles are made from virgin material and is expensive to produce. Voids in the tile both lighten the tiles and make the tile have more cushioning. The tiles connect with gravity connection and the tiles can be easily separated from an impact.

What is needed is an interlocking tile that uses virgin rubber at the interconnecting areas and recycled rubber for the bulk of the tile. The tile disclosed in this document provides a cost effective solution with a hybrid tile made of virgin and recycled crumb rubber made from recycled tires.

### BRIEF SUMMARY OF THE INVENTION

It is an object of the interlocking cushioned tiles from crumb rubber for the bulk of the tile to be made from recycled tire rubber. The use of recycled rubber reduces the amount of material in landfills. The density and size of the crumbs is variable to alter the amount of cushion for the tiles. Recycled crumb rubber particles can bonded, but the bond is fairly brittle and bonding multiple crumb rubber particles over a large cross-section increases the integrity of the bond.

It is an object of the interlocking cushioned tiles from crumb rubber to use some virgin material for interlocking elements. Virgin material bonds easily together and the bonded virgin material has high integrity to keep the interlocking keyed elements together. Virgin material is more expensive than crumb material but offer a higher resistance from tearing or separation.

It is another object of the interlocking cushioned tiles from crumb rubber to be created with a hybrid of both crumb rubber material and virgin material. The virgin material is used in areas where the tiles have high stress locations and crumb rubber where there is sufficient cross-sectional area that the crumb material sufficiently bonds to prevent pre-mature failure of the interlocking cushioned tiles.

It is another object of the interlocking cushioned tiles from crumb rubber to interconnect. The interconnection exists on all sides of the tiles and allows for a nearly infinite amount of tiles that can be connected to cover small and large areas. The connection details are essentially lollipop type interconnection male and female members. The virgin material is used in both the male and the female areas of the lollipop features while the crumb rubber is used in the bulk of the cushioned tile. The virgin material bonds to the crumb material with high bond strength. The lollipop connection provides a strong link between the tiles that can be separated if needed for replacement relocation and or repair.

It is still another object of the interlocking cushioned tiles from crumb rubber to have an integrated drain. The drain allows the any liquids that fall onto the tile to flow to edges of each individual tile and when the liquid reaches the edges of a tile, the liquid can pour down an edge of the tile and through a channel in the edge or side of the where the liquid can get channeled to a drain or collection location.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a top perspective view of a number of cushioning tiles with an edge strip.

FIG. 2 shows a detailed perspective view of a corner of a cushioning tile.

FIG. 3 shows top view of a cushioning tile.

FIG. 4 shows a side view of a cushioning tile.

FIG. 5 shows view of the bottom of a cushioning tile.

FIG. 6 shows a cross-sectional view of a cushioning tile taken from section 6-6 from FIG. 5.

### DETAILED DESCRIPTION OF THE INVENTION

FIG. 1 shows a top perspective view of a number of cushioning tiles with an edge strip. Each cushioned tile 20, 21, 22 and 23 weigh anywhere from 20 lbs to 40 lbs. depending on the thickness. Standard sizes include but are not limited to 24″×24″×1″ up to 2″ in ⅛″ intervals. The cushioned tiles are made from crumb rubber (recycled tire rubber) binder and sparingly utilize natural rubber at the interconnection areas. The design is such that the tiles will have a 1″ over and under sides with a lollipop type fastener made from natural rubber (male and female) which provide the interlocking. The lollipop type fastening. This figure further shows a trim or edge piece 24. The trim or edge piece 24 also engages onto the lollipop type fastener and provide a beveled transition from the cushioning tile to a ground surface.

Current production cushioning tiles are being fabricated as flat tiles with this system at 1″ thick and weigh approximately 20 lbs. each. This product will be used as flooring mainly. Using this method of fabrication thicker and thinner versions are contemplated and the next production version is planned with an overall thickness of 1⅜″ thick. This cushioning tile will further have integrated drainage underneath for roofing and decking applications. The underside of the cushioning tile can include voids to both reduce the weight and increase the cushioning effect.

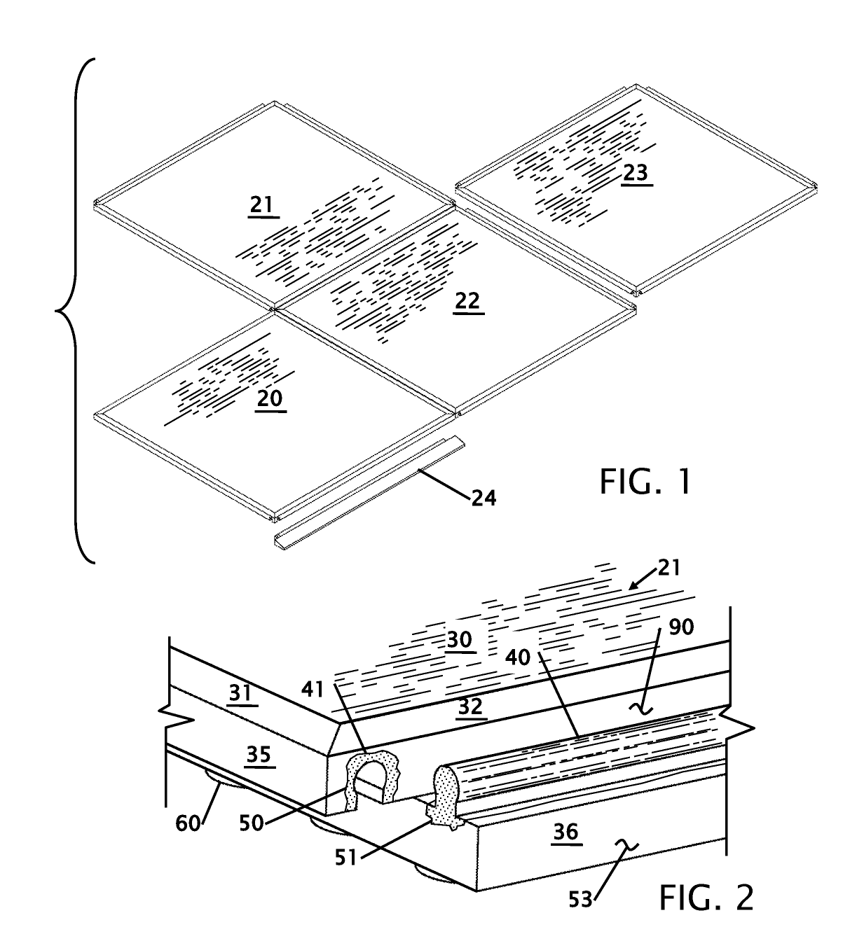

FIG. 2 shows a detailed perspective view of a corner of a cushioning tile 21. This detail is for a single tile 21 with a top surface 30. The tile 21 shows transitions 31 and 32 from the top surface 30 to the sides of the tile. The transitions 31 and 32 are on the edges and reduce the overall thickness from 1″ to ¼″ along with the inside 90 and outside 35 corners. This figure shows the male 40 lollipop detail and the female 41 lollipop detail. The male lollipop 40 shows a section of the virgin material 51 in the protrusion of the lollipop 40 on the extended side 53 of the cushioning tile 21. The female lollipop 41 shows a section of the virgin material 50 in the protrusion of the lollipop 41. The balance of the material is recycled rubber that is typically called crumb rubber.

The virgin material 50 and 51 easily bonds to the crumb rubber to make a secure connection. If the crumb rubber is used in the lollipop sections of the tile the crumb rubber does not provide a sufficient bond between the crumb elements and fails in the narrow areas of the lollipop where the lollipop bonds to the tile. The underside of the cushioning tile 21 shows a portion of an optional foot pad 60. The foot pad 60 provides both elevation for the cushioning tile 21 for drainage and for routing 70 of electrical and communication wiring under the cushioning tile 21.

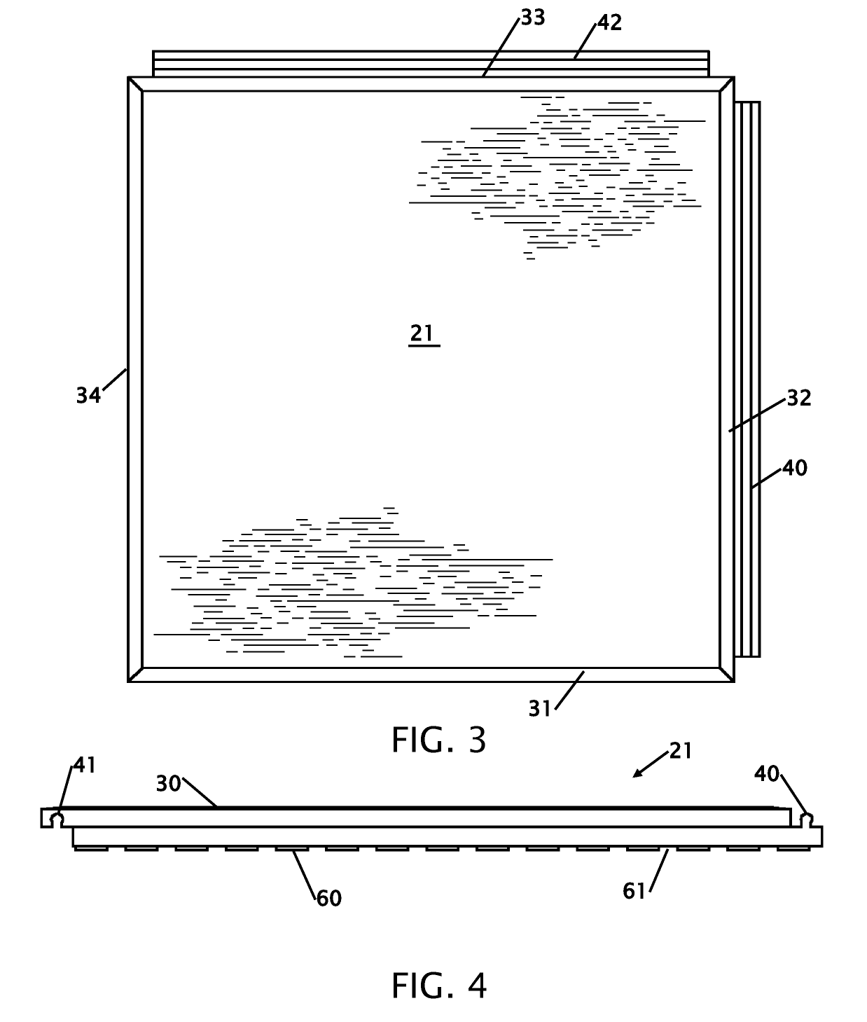

FIG. 3 shows top view of a cushioning tile 21. The top surface of the cushioning tile 21 is shown as a flat surface, but could also be fabricated with a pattern that provides a wave or other structured surface to simulate wood grain or other appearance. The four sides 31, 32, 33 and 34 of the cushioning tile 21 are essentially perpendicular with the top surface of the cushioning tile 21. A slight taper or draft from the top surface provides a transition area. Two sides of the cushioning tile 21 have male lollipop details 40 and 42. The opposing sides of the cushioning tile 21 have female details that are not visible in this figure.

FIG. 4 shows a side view of a cushioning tile 21. The top surface 30 is shown as a planar surface with the side tapered surfaces extending from the flat top surface 30. The male lollipop 40 and the female lollipop 41 details are visible in this figure. The bottom surface shows raises foot pads 60 with clearance 61 for drainage and or for routing 70 wiring under the cushioning tile 21.

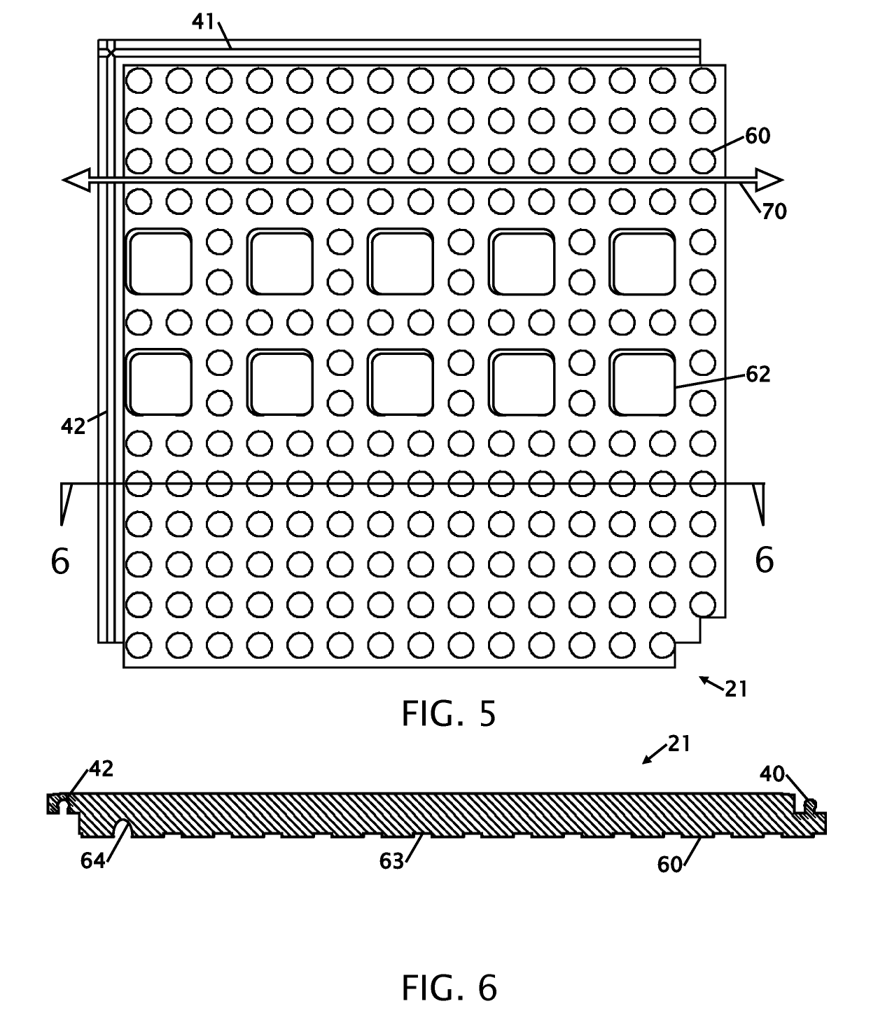

FIG. 5 shows view of the bottom of a cushioning tile 21. From this figure the female lollipop features 41 and 42 are visible. This underside view shows multiple foot pads 60. These pads are approximately 1-inch in diameter and provide an elevation of about ⅜ inch that allows the planar surface of the cushioning tile 21 to be elevated above the surrounding bottom ground. While a diameter of 1-inch and an elevation of ⅜ inch is identified these dimensions can be larger or smaller. The pads 60 are shown arraigned in rows and columns to provide clearance for wiring to run 70 under the cushioning tile 21.

This figure further shows several recess areas 62. These are another contemplated embodiment that reduces the amount of crumb rubber that is used to result in a lower weight and increased softness to the cushioning tile 21. A cross-sectional cut 6-6 is shown to provide a better understanding of the cushioning tile 21.

FIG. 6 shows a cross-sectional view of a cushioning tile taken from section 6-6 from FIG. 5. Because this cross-section cuts through the elevated pads 60 the raised and lowered areas on the bottom of the pad is visible. The clearance channels 63 are shown as a rectangular area, but this area could also be an ellipse 64 that provides clearance for round cables.

Thus, specific embodiments of interlocking cushioned tiles from crumb rubber have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. Interlocking cushioned tiles made from virgin and crumb rubber comprising:
a plurality of cushioned tiles made from a combination of virgin rubber and crumb rubber;
said virgin rubber and said crumb rubber being utilized in at least two different areas of each of said plurality of cushioned tiles;
said plurality of tiles having interlocking features wherein a first tile interconnected with at least a second tile in a parallel relationship along elongated sides of said cushioned tile;
said interlocking features comprising at least one male lollipop cross-sectional detail and at least one female lollipop cross-sectional detail;
said virgin rubber being inserted into said at least one lollipop cross-sectional detail of a cushioned tile mold and into said at least one female lollipop cross-sectional detail of said cushioned tile mold interlocking features;
filling a remainder of said cushioned tile mold with said crumb rubber, and
vulcanizing said virgin rubber to said crumb rubber whereby creating an integrated said cushioned tile.

2. (canceled)

3. The interlocking cushioned tiles made from virgin and crumb rubber according to claim 1 wherein said vulcanization bonds said crumb rubber with said virgin rubber together at interconnection of said crumb rubber and said virgin rubber communal area.

4. The interlocking cushioned tiles made from virgin and crumb rubber according to claim 1 wherein opposing elongated sides of said plurality of cushioned tiles have opposing elongated said male lollipop cross-sectional detail and said at least one female lollipop cross-sectional detail.

5. The interlocking cushioned tiles made from virgin and crumb rubber according to claim 1 that further includes an integrated drain that runs along at least one edge of said tile.

6. The interlocking cushioned tiles made from virgin and crumb rubber according to claim 1 further includes a bottom with at least one foot pad and at least one recessed area at an underside of said tile.

7. The interlocking cushioned tiles made from virgin and crumb rubber according to claim 6 wherein said at least one foot pad provides clearance for routing electrical wiring and communications cables.

8-24.
